(19) United States
(12) Patent Application Publication
(10) Pub. No.: US 2010/0194575 A1
(43) Pub. Date: Aug. 5, 2010

(54) DUAL CHANNEL ASPIRATED DETECTOR

(76) Inventor: Carlos Pedrejon Rodriguez, Castelldefels (ES)

Correspondence Address: HONEYWELL/HUSCH;Patent Services, 101 Columbia Road, P.O.Box 2245, Morrlstown, NJ, 07962, US

(21) Appl. No.: 12/362,643

(22) Filed: Jan. 30, 2009

(51) Int. Cl. G08B 17/10

(52) U.S. Cl. 340/628

(57) ABSTRACT

A dual channel aspiring smoke detector includes ultrasonic flow sensors associated with each channel. The detector can make determinations of smoke levels associated with respective channels as well as rates of flow through each channel. Respective alarm or trouble indicators can be output in response to determined smoke levels as well as determined flow rate. The detector can be used as a stand alone device or part of a fire alarm system.

### FIELD

The invention pertains to aspirated smoke detectors. More particularly, the invention pertains to such detectors which include ultrasonic flow sensors.

### BACKGROUND

Aspirating smoke detectors draw air from a protected area using a network of sampling pipes. The sampled air is then passed through one or two smoke sensors. Smoke levels can be evaluated locally or transmitted to a displaced system control unit for alarm determination.

In known aspirating detectors, a fan is used to draw the sampled air into the unit and for providing the sampled air to the smoke sensor or sensors. Detectors can be operated as stand alone devices or as an element in a fire alarm system. Local relays can be provided to provide fault indicators or to activate one or more alarm devices such as sounders or strobes.

### BRIEF DESCRIPTION OF THE DRAWINGS

FIG. 1 is an overall configuration diagram including a detector in accordance with the invention;

FIG. 2 is an isometric view of the detector of FIG. 1;

FIGS. 3A, 3B are views of the detector of FIG. 2 with the front cover removed to illustrate internal details;

FIG. 4 is an overall all block diagram of the detector of FIG. 1;

FIG. 5 illustrates aspects of the ultrasonic transducers of the detector of FIG. 1;

FIG. 6 is a flow diagram illustrating aspects of operation of the detector of FIG. 1; and

FIGS. 7A, 7B illustrate information presentable on a display of the detector of FIG. 1.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

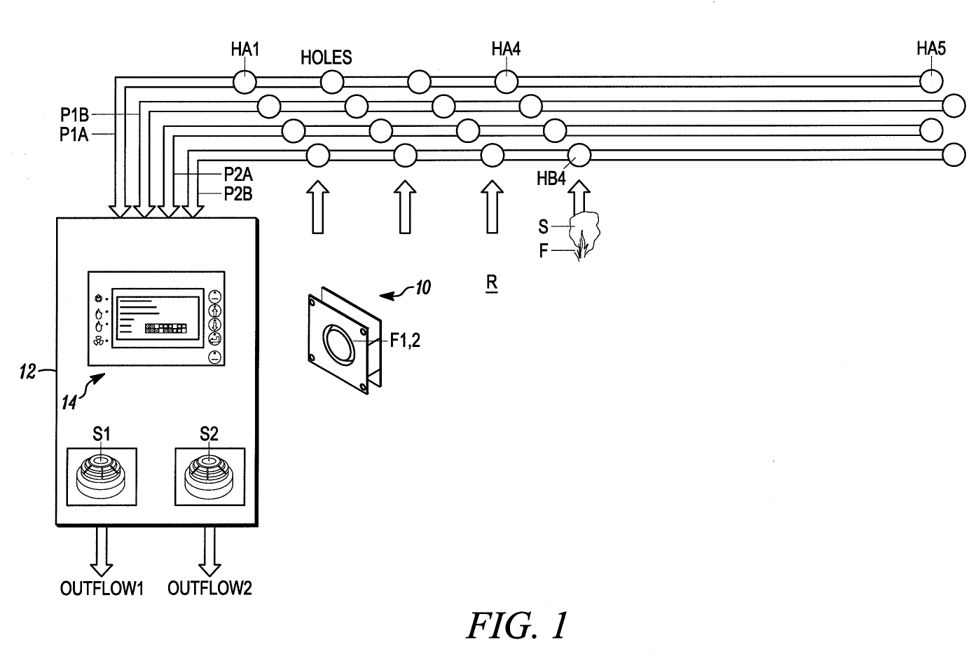

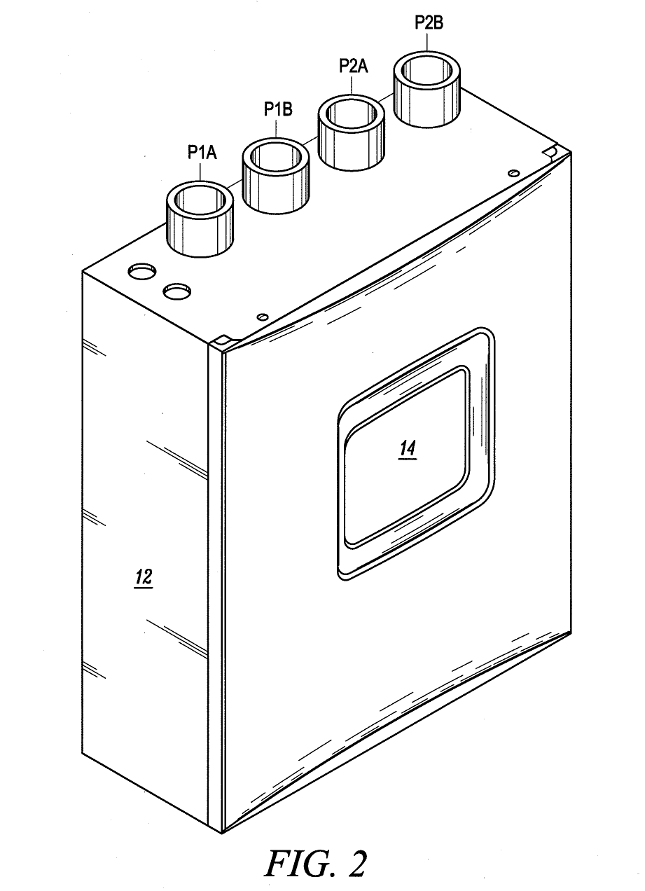

FIG. 1 is a diagram of a detector 10, which embodies the invention coupled to a plurality of atmospheric flow pipes such as P1A, P1B, P2A, P2B. Each of the pipes includes a plurality of inflow ports, or holes, such as HA1 . . . HA4 and HA5 associated with pipe P1A.

The flow pipes each terminate at an outflow opening and are connected to a cabinet 12 of detector 10. Smoke S, from a fire F in a region R being monitored can be drawn into an adjacent flow pipe, such as P2B, through an opening such as HB4.

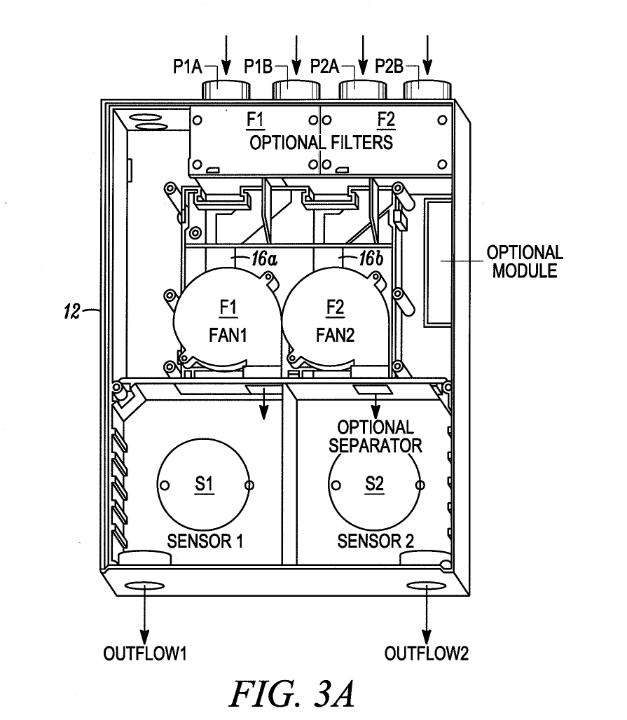

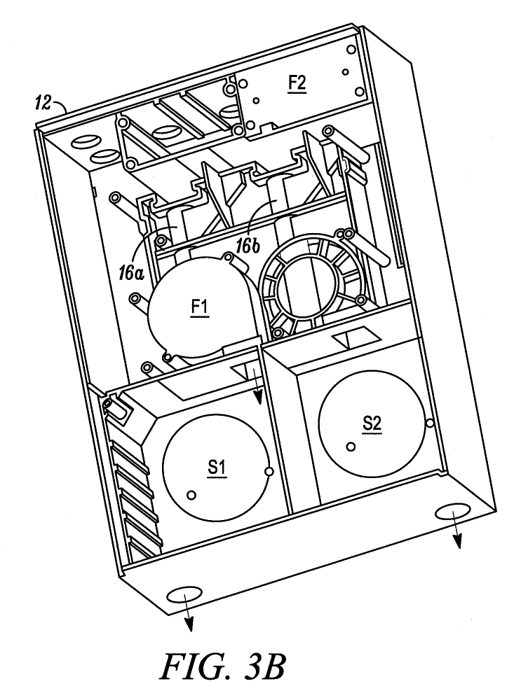

Aspirators, or fans, F1, F2 carried by cabinet or housing 12 draw ambient air, or fluid, through respective pipes such as P1A, P1B, P2A or P2B and into respective flow channels such as 16a, b (best seen in FIG. 3A) in cabinet 12. Ambient air drawn through detector 10 exits from two outflow ports, Outflow1 and Outflow2.

Detector 10 also includes a user interface device 14 which includes a display 14a and user inputs 14b, both carried by housing 12 and optional filters F1, F2 (best seen in FIG. 3a). Housing 12 also carries local control circuits 18 coupled to sensors S1, S2.

Housing 12 also carries ultrasonic transducers 20a,b associated with flow channel 16a and 22a,b associated with channel 16b. The transducers are supported in the housing 12 on a printed circuit board 24 which also carries the control circuits 18 and the interface device 14. The transducers 20a,b and 22a,b are each transmitters and receivers and establish air flow speed n the channels 16a,b by comparing transit time for each channel in both directions relative to air flow. The difference in transit times is indicative of speed of air flow in the respective channel.

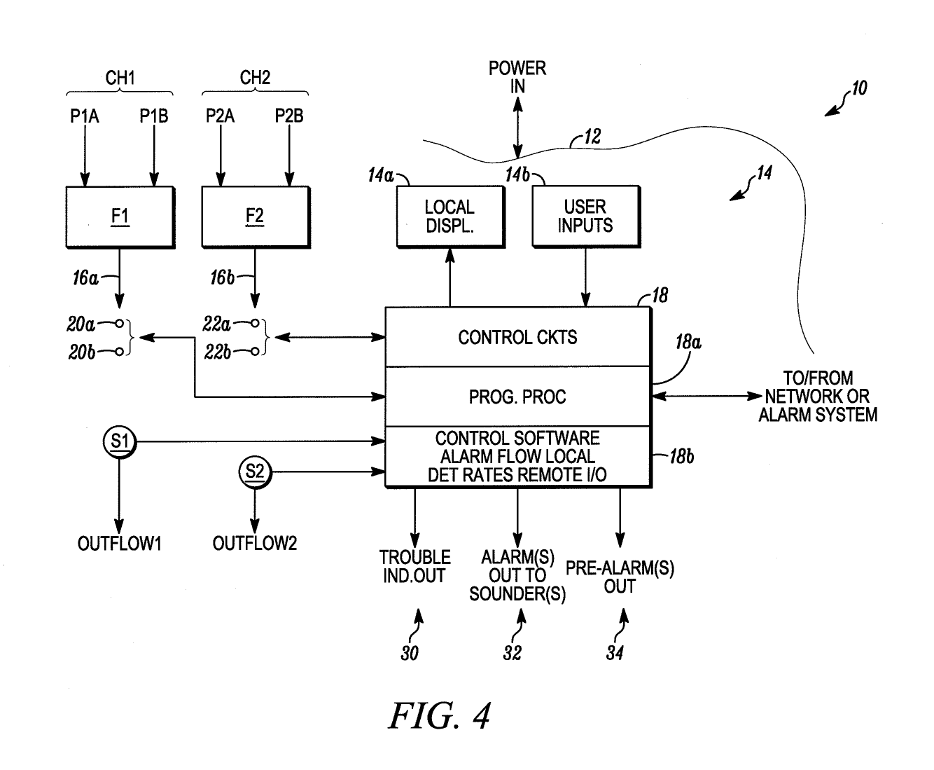

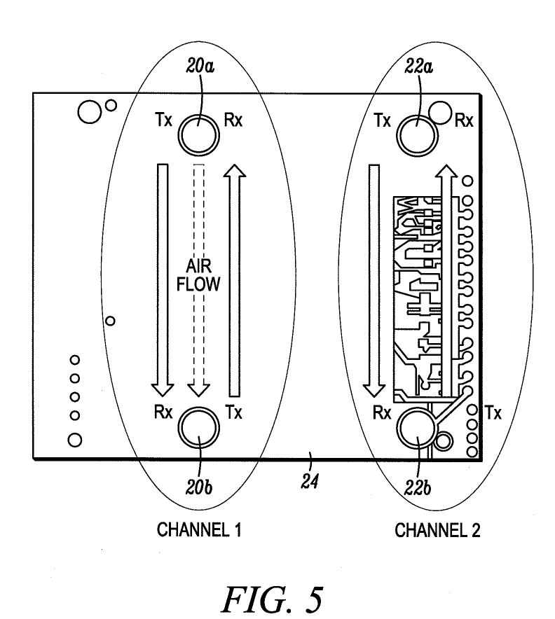

FIG. 4 illustrates added details of detector 10. Outputs from smoke sensors S1, S2 and ultrasonic sensors 20a,b and 22a,b are coupled to the control circuits 18 on the printed circuit board 24. The control circuits 18 can be implemented at least in part with a programmable processor 18a and associated pre-stored control circuitry 18b. The processor 18a and control software 18b can evaluate outputs from smoke sensors S1, S. Sensors S1, S2 can make pre-alarm and alarm determinations, as would be understood by those of skill in the art. Alternately, smoke level signals can be coupled to the control circuits 18 for the purpose of making such determinations.

The control circuits 18 can also emit outputs 30, trouble signals indicative of conditions that need to be addressed at the detector 10. One form of output device is a relay. Other outputs include sounder, audible alarm devices, output signals 32 as well as pre-alarm or alarm indicating outputs 34 for channels 16a,b if desired.

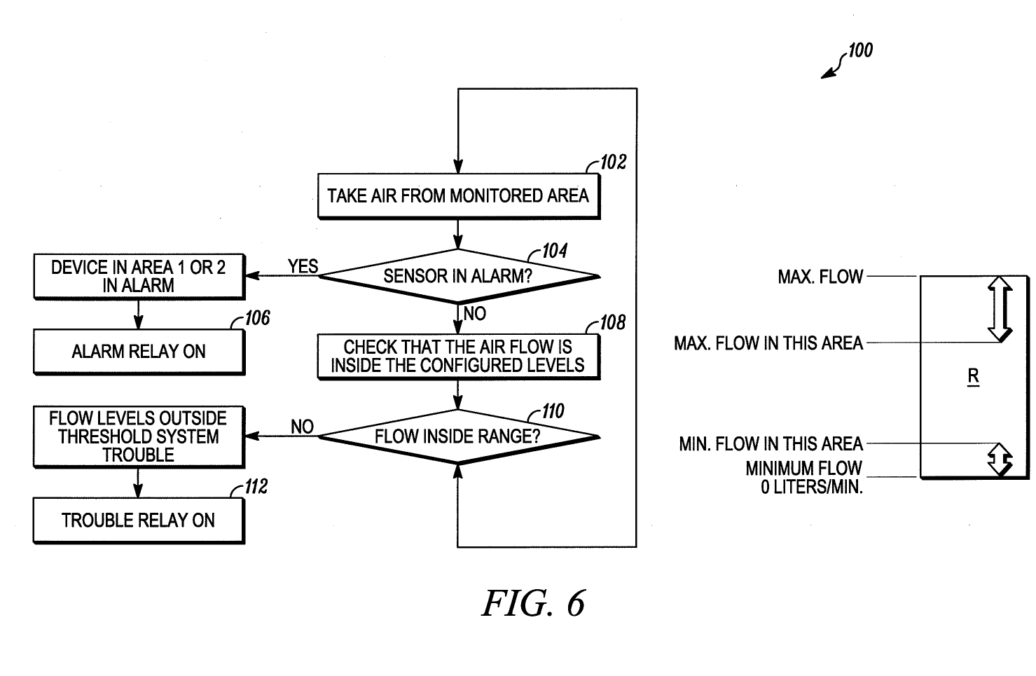

FIG. 6 illustrates aspects of a method 100 in accordance with the invention. Air samples are acquired via pipes P1A, P2A for example as at 102. Those samples are evaluated, as at 104 to establish the presence of one or more alarm conditions. Responsive to an established alarm condition, an alarm indicating output to an output device or a displaced alarm system can be emitted as at 106. In the absence of an alarm condition, air flow rate in the channels 16a,b can be established as at 108. Where the established flow rate(s) are outside of expected range(s) a trouble output can be generated, as at 112.

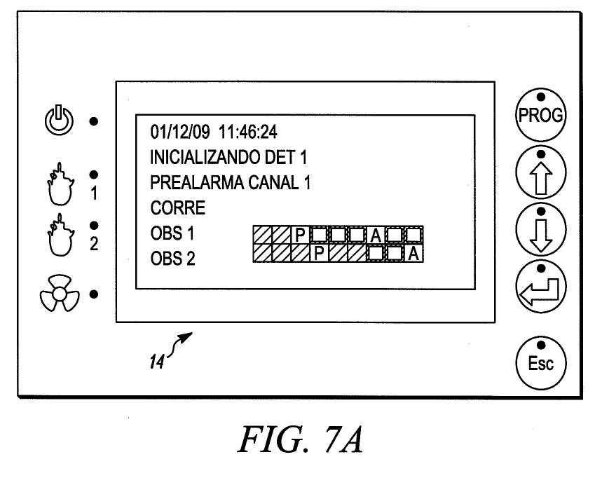

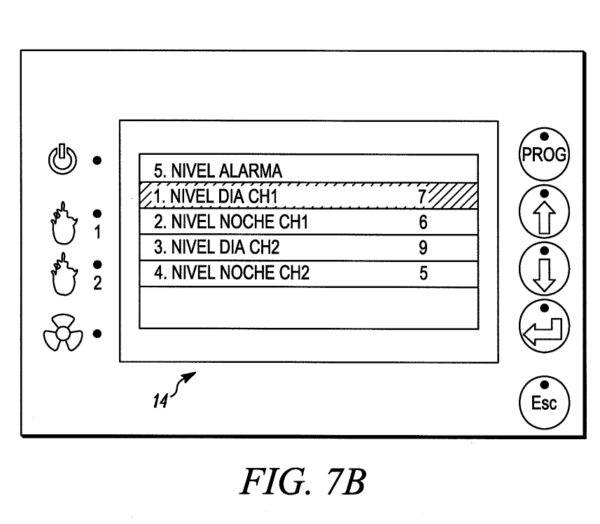

FIGS. 7A and 7B illustrate various output displays available on the output device 14a. FIG. 7A illustrates smoke levels in each channel, OBS1, OBS2. Channel 1 is showing that smoke level has reached pre-alarm level three with an alarm to be issued at level seven.

FIG. 7B illustrates two different pre-alarm and alarm levels, dependent on day/night sensitivity. Channel one, 16a has a day alarm at level seven and a night alarm at level six. Channel two 16b, has a day alarm at level nine and a night alarm at level six.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. An aspirated detector comprising:
a housing having a plurality of air inflow ports;
first and second aspirators, carried by the housing, with each aspirator adjacent to at least one inflow port;
first and second smoke sensors, carried by the housing, wherein the housing defines fluid flow paths between first aspirator and sensor and second aspirator and sensor;
first and second ultrasonic transducers, one transducer is associated with each flow path to establish a rate of flow therein; and
control circuits coupled to the sensors and the transducers.

2. A detector as in claim 1 where the housing defines an internal region which receives the sensors with the region bisected by a removable panel which, when present, divides the region into two separate sub-regions.

3. A detector as in claim 1 which includes output relays and where the control circuits activate selected relays in response to output signals from the sensors.

4. A detector as in claim 1 which includes output relays and where the control circuits activate selected relays in response to output signals from the transducers.

5. A detector as in claim 4 which includes third and fourth ultrasonic transducers with the first and third adjacent to one flow path and the second and fourth adjacent to another flow path.

6. A detector as in claim 1 where the control circuits, responsive to an alarm condition, produce an electrical output which can activate an alarm indicating output device.

7. A detector as in claim 6 where the control circuits detect a flow rate associated with one of the fluid flow paths.

8. A detector as in claim 7 where the control circuits, responsive to detected flow rate, outputs a flow rate out of range indicator.

9. A detector as in claim 8 where the control circuits detect a second flow rate, associated with the other flow path, and, responsive thereto outputs a second out of range indicator.

10. A detector as in claim 5 where the control circuits, responsive to an alarm condition, produce an electrical output which can activate an alarm indicating output device.

11. A detector as in claim 10 where the control circuits detect a flow rate associated with one of the fluid flow paths.

12. A detector as in claim 11 where the control circuits, responsive to detected flow rate, outputs a flow rate out of range indicator.

13. A detector as in claim 12 where the control circuits detect a second flow rate, associated with the other flow path, and, responsive thereto outputs a second out of range indicator.

14. A method comprising:
establishing multiple, ported fluid flow paths which each have an output end;
establishing first and second locations adjacent to respective ends through which fluid is drawn from a respective output end;
directing fluid from the locations into respective first and second sensing regions;
establishing first and second fluid born particulate indicium for each sensing region; and
establishing first and second fluid flow rates associated with respective locations.

15. A method as in claim 14 which includes, responsive to the particulate indicium, establishing at least one alarm indicator associated with a respective fluid.

16. A method as in claim 15 which includes, responsive to the particulate indicium, establishing at least one pre-alarm indicator associated with a respective fluid.

17. A method as in claim 16 which includes displaying at least one of the pre-alarm, or the alarm indicium.

18. A method as in claim 17 which includes displaying at least one flow rate.

19. A method as in claim 18 which includes selectively displaying one of a plurality of alarm indicia, or a plurality of flow rates.

20. A method as in claim 19 which includes transferring selected indicia to a displaced fire alarm detecting system.
